(19) United States
(12) Patent Application Publication
(10) Pub. No.: US 2025/0092966 A1
(43) Pub. Date: Mar. 20, 2025

(54) RV Hookup Organizer

(71) Applicant: DISTINCTIVE GOODS LLC, Sioux Falls, SD (US)

(72) Inventor: Phillip Allen, Sioux Falls, SD (US)

(21) Appl. No.: 18/370,217

(22) Filed: Sep. 19, 2023

(51) Int. Cl. F16L 3/26; B60R 15/00

(52) U.S. Cl. CPC F16L 3/26; B60R 15/00

(57) ABSTRACT

A device which allows owners of RVs to organize a full hookup. The device comprises of a plurality of extendable and retractable interconnected molds with three “U” shaped descending cradles to support a sewer hose, water hose, and electrical cord. The RV hookup organizer allows for the sewer hose, water hose, and electrical cord to better withstand adverse weather and environmental conditions.

### PRIOR ART

While there is prior art such as U.S. Pat. Nos. 6,619,596, 11,208,057, and 7,425,028 in the field of sewer hose supports from RVs, however, there is not an RV hookup organizer that accommodates a sewer hose, water hose, and power.

### BACKGROUND OF THE INVENTION

Traditional RV sewer support organizers are designed to only handle the sewer hose, but the average RV owner has a greater organizational need than only for a sewer hose.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

The present subject matter allows owners of RVs to organize a full hookup. The present subject matter comprises of a plurality of extendable and retractable interconnected molds with three “U” shaped descending cradles to support a sewer hose, water hose, and electrical cord.

The RV hookup organizer allows for the sewer hose, water hose, and electrical cord to better withstand adverse weather conditions.

The present subject matter has multiple straps to secure the “U” shaped molds together while in transportation.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation.

The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

### BRIEF DESCRIPTION OF DRAWINGS

FIG. 1 shows a front view of the RV hookup organizer.

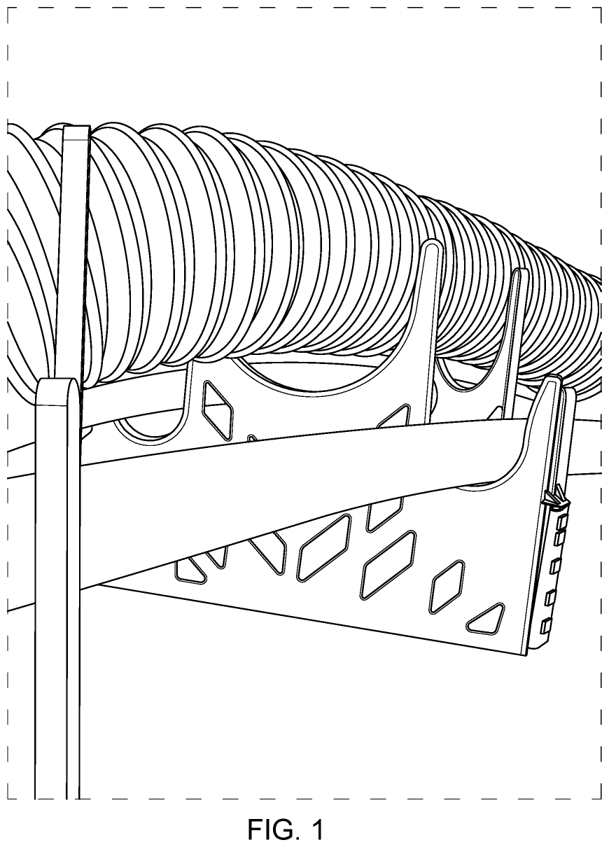

FIG. 2 shows a back perspective view of the RV hookup organizer in use.

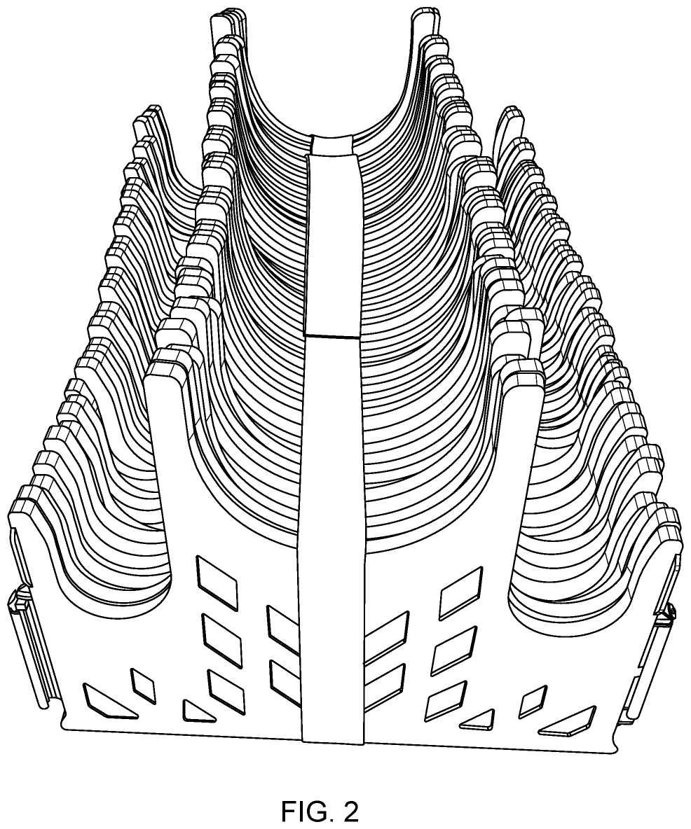

FIG. 3 shows a perspective view of the RV hookup organizer.

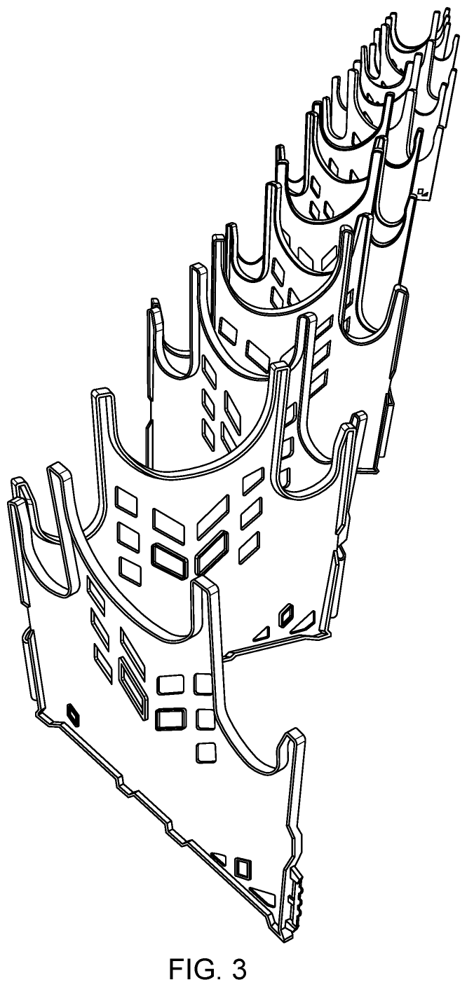

1. An RV hookup organizer comprising of a plurality of extendable and retractable interconnected molds with three “U” shaped descending cradles.

2. The RV hookup organizer comprising of the plurality of extendable and retractable interconnected molds with three “U” shaped descending cradles as in claim 1, wherein the RV hookup organizer is designed to accommodate a sewer hose, water hose, and electrical cord.

3. The RV hookup organizer comprising of the plurality of extendable and retractable interconnected molds with three “U” shaped descending cradles as in claim 1, wherein the cradles descend to help facilitate the movement of sewage and water.

4. The RV hookup organizer comprising of the plurality of extendable and retractable interconnected molds with three “U” shaped descending cradles as in claim 1, wherein the RV hookup organizer protects the sewer hose, water hose, and electrical cord from adverse weather and other environmental conditions.

5. The RV hookup organizer comprising of the plurality of extendable and retractable interconnected molds with three “U” shaped descending cradles as in claim 1, wherein the hookup organizer has multiple straps to secure the “U” shaped molds while in transportation.

6. A method of manufacturing an RV hookup organizer comprising of a plurality of extendable and retractable interconnected molds with three “U” shaped descending cradles.

7. The method of manufacturing the RV hookup organizer comprising of the plurality of extendable and retractable interconnected molds with three “U” shaped descending cradles as in claim 7, wherein the RV hookup organizer is designed to accommodate a sewer hose, water hose, and electrical cord.

8. The method of manufacturing the RV hookup organizer comprising of the plurality of extendable and retractable interconnected molds with three “U” shaped descending cradles as in claim 7, wherein the cradles descend to help facilitate the movement of sewage and water.

9. The method of manufacturing the RV hookup organizer comprising of the plurality of extendable and retractable interconnected molds with three “U” shaped descending cradles as in claim 7, wherein the RV hookup organizer protects the sewer hose, water hose, and electrical cord from adverse weather and other environmental conditions.

10. The method of manufacturing the RV hookup organizer comprising of the plurality of extendable and retractable interconnected molds with three “U” shaped descending cradles as in claim 7, wherein the hookup organizer has multiple straps to secure the “U” shaped molds while in transportation.
